(19) United States
(12) Patent Application Publication
(10) Pub. No.: US 2020/0150425 A1
(43) Pub. Date: May 14, 2020

(54) INCONSPICUOUS NEAR-EYE ELECTRICAL COMPONENTS

(71) Applicant: Facebook Technologies, LLC, Menlo Park, CA (US)

(72) Inventors: Karol Constantine Hatzilias, Kenmore, WA (US); Robin Sharma, Redmond, WA (US); Christopher Yuan Ting Liao, Seattle, WA (US); Andrew Ouderkirk, Redmond, WA (US)

(21) Appl. No.: 16/224,245

(22) Filed: Dec. 18, 2018

Related U.S. Application Data
(60) Provisional application No. 62/758,422, filed on Nov. 9, 2018.

(51) Int. Cl. G02B 27/00; G02B 27/01

(52) U.S. Cl. CPC G02B 27/0093; G02B 2027/0178; G02B 27/0172; G02B 27/0101

(57) ABSTRACT

A near-eye optic includes a substrate having a clear aperture for propagating light. A plurality of inconspicuous electrical components is supported by the substrate in the clear aperture of the substrate. The inconspicuous electrical components may be disposed in an inconspicuous pattern and may be electrically coupled to a plurality of inconspicuous conductive traces, which may also be disposed in an inconspicuous pattern. The inconspicuous pattern may include e.g. an asymmetric pattern, an aperiodic pattern, a pseudo-random pattern, a meandering pattern, a periodic pattern modulated with pseudo-random perturbations, or a non-rectangular pattern modulated with pseudo-random perturbations.

### REFERENCE TO RELATED APPLICATION

The present application claims priority from U.S. Provisional Application No. 62/758,422 filed on Nov. 9, 2018, and incorporated herein by reference in its entirety.

### TECHNICAL FIELD

The present disclosure relates to near-eye devices, and in particular to wearable optical, optoelectronic, and electro-optical devices for eye region tracking, their components, modules, and related methods of manufacture and operation.

### BACKGROUND

Near-eye optics (NEO) are used to correct vision defects, gather information about eye position and orientation, capture an external visual scene for a user, or, when coupled with additional electronics such as a near-eye display, to augment a real scene with additional information or virtual objects. In some NEO systems, a head, face, and/or eye position and orientation of the user are tracked using a near-eye tracker (NET), and the tracked information is used to infer the user's intent, communicate the user's facial expression, or to augment a real-world scene with virtual images, symbols, or signs.

The eye region may be tracked by illuminating the eye with an array of miniature illuminators. Real-time images of the illuminated eye are obtained using a dedicated imaging system, and fed to a controller. It is desirable to increase fidelity and reliability of eye tracking.

### BRIEF DESCRIPTION OF THE DRAWINGS

Exemplary embodiments will now be described in conjunction with the drawings, in which:

FIG. 1 is a schematic frontal view of a near-eye optic;

FIG. 2 is a schematic isometric view of a substrate of the near-eye optic of FIG. 1, the substrate supporting an electrical component and conductive traces;

FIG. 3A is an exemplary schematic view of an asymmetric inconspicuous pattern;

FIG. 3B is an exemplary schematic view of an aperiodic inconspicuous pattern;

FIG. 3C is an exemplary schematic view of a pseudo-random inconspicuous pattern;

FIG. 3D is an exemplary schematic view of a meandering inconspicuous pattern;

FIG. 3E is an exemplary schematic view of a periodic inconspicuous pattern modulated with pseudo-random perturbations;

FIG. 3F is an exemplary schematic view of a polar angle inconspicuous pattern modulated with pseudo-random perturbations;

FIG. 4 is a schematic view of different viewing regions of a near-eye optic;

FIG. 5A is a side cross-sectional view of a near-eye optic comprising an active focusing optic;

FIG. 5B is a side cross-sectional view of a near-eye optic comprising an attenuator or shutter;

FIG. 5C is a side cross-sectional view of a near-eye optic comprising a near-eye tracker;

FIG. 6 is a side cross-sectional view of a near-eye optic comprising a stack of functional substrates;

FIGS. 7A and 7B are schematic frontal and side cross-sectional side views, respectively, of a near-eye tracker according to an embodiment;

FIG. 8 is a schematic top view of a near-eye illuminator;

FIG. 9 is a schematic top view of near-eye illuminator clusters;

FIG. 10 is a schematic top view of extended near-eye illuminators;

FIGS. 11A and 11B are schematic frontal and side cross-sectional side views, respectively, of a near-eye display according to an embodiment;

FIG. 12 is a flow chart of a method of manufacturing a near-eye illuminator;

FIG. 13A is an isometric view of an eyeglasses form factor near-eye AR/VR display incorporating illuminators of the present disclosure;

FIG. 13B is a side cross-sectional view of the near-eye AR/VR display of FIG. 13A; and

FIG. 14 is an isometric view of an HMD incorporating illuminators of the present disclosure.

### DETAILED DESCRIPTION

While the present teachings are described in conjunction with various embodiments and examples, it is not intended that the present teachings be limited to such embodiments. On the contrary, the present teachings encompass various alternatives and equivalents, as will be appreciated by those of skill in the art. All statements herein reciting principles, aspects, and embodiments of this disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

As used herein, the terms “first”, “second”, and so forth are not intended to imply sequential ordering, but rather are intended to distinguish one element from another, unless explicitly stated. Similarly, sequential ordering of method steps does not imply a sequential order of their execution, unless explicitly stated.

In accordance with the present disclosure, there is provided a near-eye optic comprising a substrate having a clear aperture for propagating light through the aperture, and a plurality of inconspicuous electrical components supported by the substrate in the clear aperture of the substrate. The inconspicuous electrical components are electrically coupled to a plurality of inconspicuous conductive traces. In some embodiments, the electrical components are disposed at least 5 mm away from each other. In some embodiments, the electrical components have a width and a length of less than 0.5 mm. In some embodiments, the plurality of inconspicuous electrical components lacks electrical components disposed within 12 degrees of an optic axis of the clear aperture.

The substrate is preferably transparent for visible light across the clear aperture. The electrical components may be disposed in a plurality of individually shaped clusters of components; a distance between any two components in a cluster of the plurality of clusters is less than a cluster size, and a distance between any two clusters of the plurality of clusters is greater than a minimal inter-cluster distance. The near-eye optic may include at least one of: a near-eye tracker, display, a prescription lens, an active focusing optic, an attenuator, or a shutter.

In embodiments where the near-eye optic comprises a near-eye tracker, the electrical components may include illuminators configured to provide illuminating light to an eye region for eye tracking. The illuminators may have different pre-defined optical power levels. The illuminators may include extended light sources, each extended light source having a different lateral distribution of optical power density. In embodiments where the near-eye tracker comprises an imaging system for imaging the eye region, the substrate may include an optical element, e.g. a switchable lens and/or a switchable grating, for redirecting a least a portion of the illuminating light reflected from the eye region towards the imaging system.

In accordance with the present disclosure, there is provided a near-eye display (NED) comprising an electronic display for providing display light to an eyebox of the NED, an illumination substrate having a clear aperture in a field of view of the NED for propagating the display light from the electronic display through the clear aperture, and a plurality of inconspicuous illuminators for providing illuminating light to an eye region of a user of the NED. The inconspicuous illuminators are supported by the illumination substrate in the clear aperture of the illumination substrate. The inconspicuous illuminators are electrically coupled to a plurality of inconspicuous conductive traces for providing electrical power to the plurality of inconspicuous illuminators.

The NED may further include an imaging system and an imaging substrate in a stack configuration with the illumination substrate. The imaging substrate may include an optical element for redirecting a least a portion of the illuminating light reflected from the eye region towards the imaging system. The electronic display may include a pupil-replicating waveguide for guiding the display light and outputting the display light at a plurality of offset locations at a proximal outer surface of the pupil-replicating waveguide. The illumination substrate, the imaging substrate, and the pupil-replicating waveguide may be disposed in a stack configuration, such that the proximal outer surface of the pupil-replicating waveguide is facing a distal surface of the imaging substrate.

In accordance with the present disclosure, there is further provided a method of manufacturing a near-eye optic. The method may include providing a substrate having a clear aperture for propagating light through the clear aperture, disposing within the clear aperture of the substrate a plurality of inconspicuous electrical components, and electrically coupling the plurality of inconspicuous electrical components to a plurality of inconspicuous conductive traces. The inconspicuous conductive traces may be disposed in an inconspicuous pattern comprising at least one of: an asymmetric pattern, an aperiodic pattern, a pseudo-random pattern, a meandering pattern, a periodic pattern modulated with pseudo-random perturbations, or a non-rectangular pattern. The plurality of inconspicuous electrical components may lack electrical components disposed within 12 degrees of an optic axis of the clear aperture, which is preferably transparent for visible light.

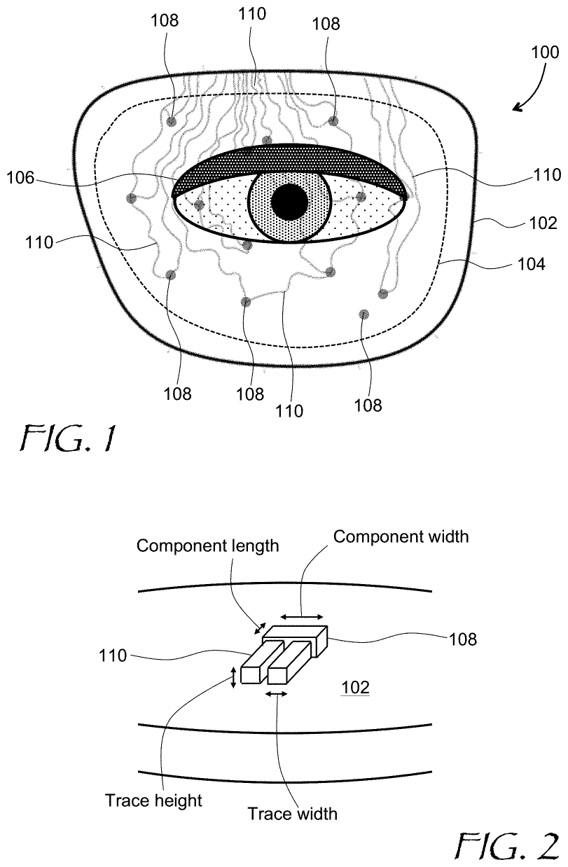

Referring now to FIG. 1, a near-eye optic (NEO) 100, such as a near-eye display (NED) or a near-eye tracker (NET), includes a substrate 102 having a clear aperture 104 for propagating light generally towards an eye 106. The light may be, for example, external light from outside environment, NEO internally generated light, light from an integrated display or from an external display, and the substrate 102 can be transparent for the light in the clear aperture 104. The clear aperture 104 receives the light for performing intended function of the NEO 100. The light may be in the visible wavelength range, or in a different range, such as infrared (IR) or ultraviolet (UV).

A plurality of inconspicuous electrical components 108 are supported by the substrate 102 in the clear aperture 104 of the substrate 102. The electrical components 108 may include, for example, light-emitting diodes (LEDs), laser diodes (LDs) such as vertical cavity surface-emitting lasers (VCSELs) or side-emitting laser diodes, photodiodes, transistors, resistors, capacitors, etc., or more generally any miniature optical, electro-optical, optoelectronic, or electrical components or sensors that may benefit from in-sight placement. The sensors and/or detectors may detect various parameters such as eye distance, illumination level, pupil dilation, etc. The term “inconspicuous” means not immediately noticeable by either the wearer of the NEO 100 or outside observers such as other persons in direct face-to-face communication with a wearer of the NEO. Opaque electrical components such as LEDs, VCSELs, or photodiodes, are often imperceptible to the user wearing the NEO at an eye relief distance closer than 25 mm from the eye 106 when the electrical components are less than 500 μm in length and less than 500 μm in width. The length and width of the electrical components are illustrated in FIG. 2. Opaque electronics that are less than 100 μm are often imperceptible to an outside observer who is greater than 200 mm away from the NEO 100. It is also possible to fabricate and incorporate transparent or semi-transparent electronics such as capacitors and resistors, which can be incorporated into the NEO. These transparent or semi-transparent electrical components can be imperceptible at different sizes and distances than opaque inconspicuous electrical components.

The electrical components 108 of FIG. 1 are electrically coupled to a plurality of inconspicuous conductive traces 110 for powering the electrical components 108, for receiving electrical signals from the electrical components 108, or both. For users wearing the NEO 100 closer than 25 mm from the eye 106, opaque conductive traces are often imperceptible if they are less than 50 82 m wide and no greater than 50 μm in height (FIG. 2). For an external observer greater than 200 mm away observing someone wearing the NEO 100, the conductive traces are often imperceptible if they are less than 25 μm wide and less than 25 μm in height. The distance of 200 mm away is much closer than a distance in most social contact situations. Transparent traces can be inconspicuous at different sizes and distances than opaque traces at this distance.

In accordance with the present disclosure, the electrical components 108 may be disposed in an inconspicuous pattern. The inconspicuous pattern is any pattern that is not immediately familiar or recognizable by a human eye. By way of non-limiting examples, the electrical components 108 may be disposed in a periodic pattern such as a sinusoid, an asymmetric pattern, an aperiodic pattern, a repeating random, a repeating pseudo-random pattern, a non-linear pattern, a pseudo-random pattern, a meandering pattern, a non-circular pattern, a periodic pattern modulated with random or pseudo-random perturbations, a geometric (arcs, circles, sinusoids, etc.) pattern modulated with random or pseudo-random perturbations, and/or a non-rectangular pattern.

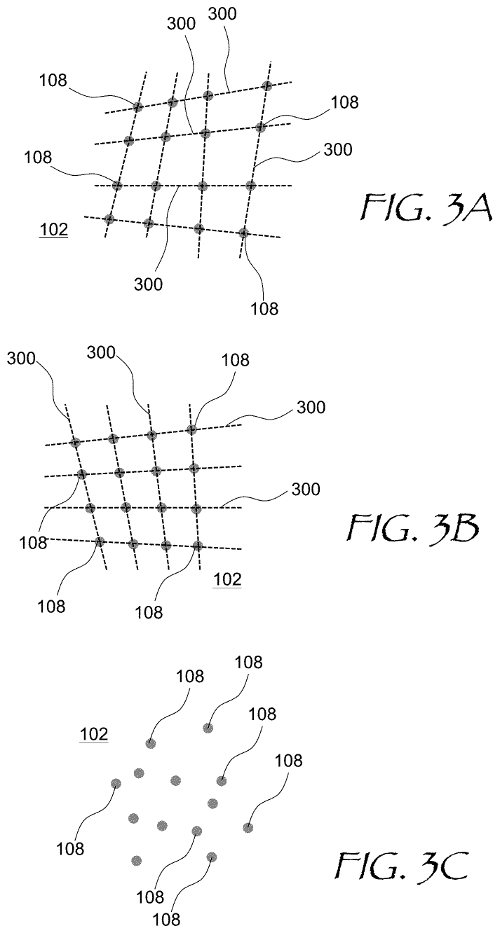

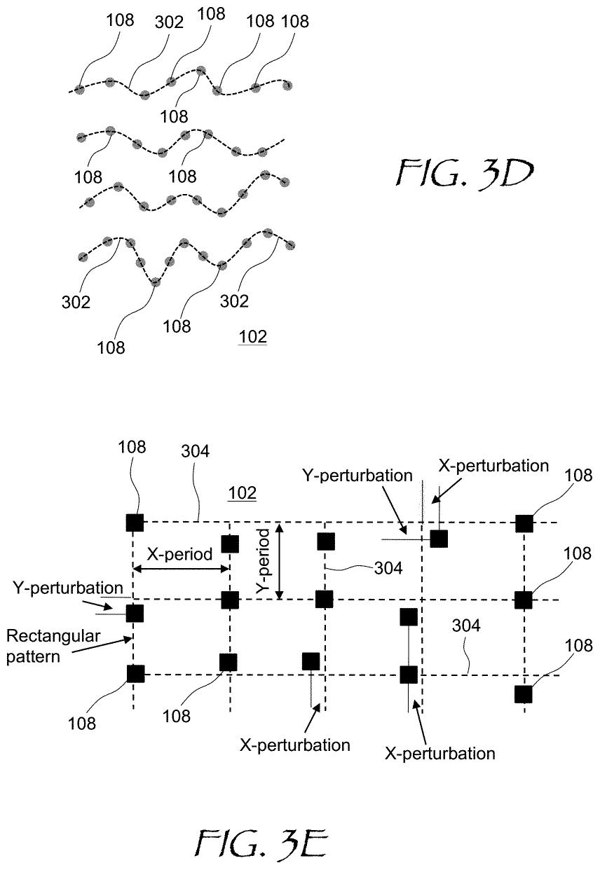

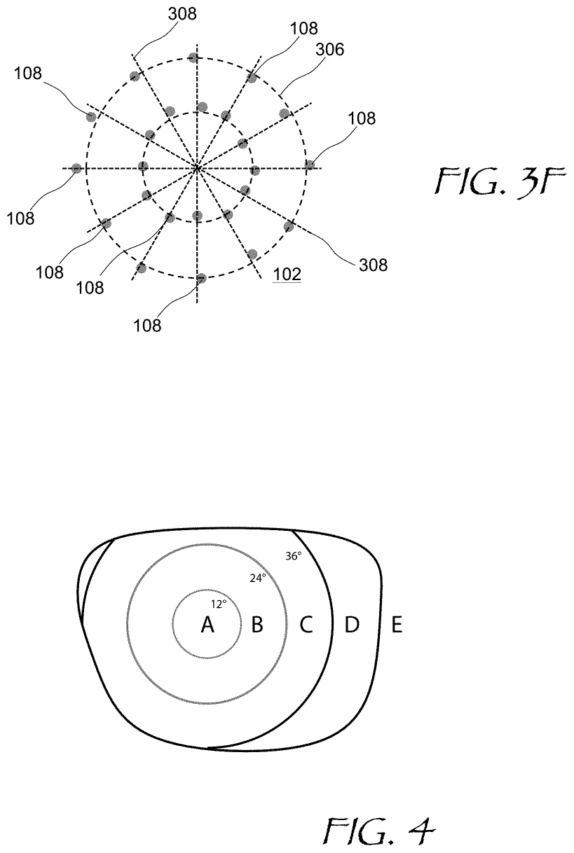

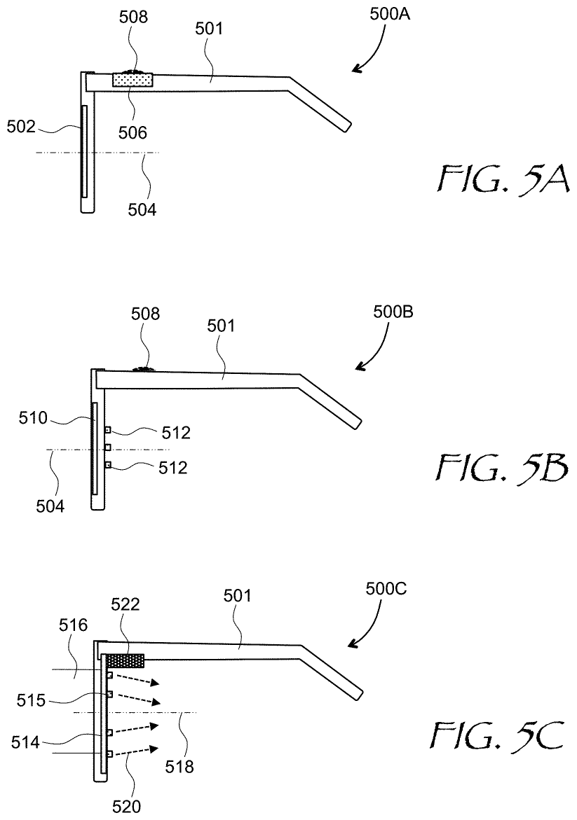

FIG. 3A shows an example of the electrical components 108 disposed on the substrate 102 in an asymmetric pattern. The asymmetric pattern is represented by dashed lines 300. The electrical components are placed at the crossing points of the dashed lines 300. An asymmetric pattern lacks an axis of symmetry, e.g. left and right, or top and bottom groups of the electrical components 108 cannot be mirrored onto one another. An asymmetric pattern may be inconspicuous because an eye of a user subconsciously looks for symmetry in observed shapes, and consequently asymmetric shapes can be less noticeable to the eye.

FIG. 3B shows the electrical components 108 disposed on the substrate 102 in an aperiodic pattern. Neighboring electrical components 108 are disposed at the crossing points of the dashed lines 300, at different distances from each other along the dashed lines 300. The distances between neighboring pairs may gradually increase or decrease, or may be completely random or pseudo-random. An aperiodic pattern tends to be inconspicuous because it is difficult for an eye to predict.

FIG. 3C shows an example of the electrical components 108 arranged in a random or pseudo-random pattern on the substrate 102. Throughout this specification, the terms “random” or “pseudo-random” are interchangeable and refer to a pattern which appears random, even though it may have been obtained through a deterministic algorithm providing x, y coordinates of the electrical components 108 by processing some seed number, which may be randomly picked. Random patterns may be difficult for an eye to “grab” and interpret, and thus may appear inconspicuous.

FIG. 3D shows another example of inconspicuous placement of the electrical components 108. The electrical components 108 of FIG. 3D are disposed along meandering, waving, or wiggling lines 302 which make random turns of different amplitudes to the left and to the right, not necessarily in order. Since the meandering lines 302 are difficult for an eye to predict or follow, the electrical components 108 are less noticeable.

FIG. 3E illustrates the electrical components 108 disposed on the substrate 102 with pseudo-random offsets, or perturbations, from positions of a periodic rectangular grid pattern 304. It is noted that some of the electrical components 108 may remain on-grid 304, that is, some of the pseudo-random perturbations may be zero. The pseudo-random perturbations can make the grid of the electrical components 108 less noticeable, in comparison with the electrical components 108 disposed strictly on-grid 304. The amplitude of X- or Y-perturbations may be e.g. at least 1%, 2%, 5%, 10%, 20%, or 50% of the corresponding X or Y grid period, for example. In some embodiments, the amplitudes of perturbations are less than a fixed threshold distance, e.g. less than 2 mm, 5 mm, or 10 mm. Other types of regular grids that may be modulated with random or pseudo-random perturbations include azimuthal grids having regularly spaced azimuth angle and radius, hexagonal or polygonal grids, radial grids, etc.

Referring to FIG. 3F, a polar angle grid is formed by equidistant azimuthal lines 306 and equiangular radial lines 308. The electrical components 108 are disposed near points of intersections of the azimuthal lines 306 and the radial lines 308, with pseudo-random offsets from the points of intersections, to make the disposition pattern of the electrical components 108 less conspicuous, that is less noticeable to a human eye. The amplitude of the offsets may be e.g. at least 1%, 2%, 5%, 10%, 20%, or 50% of the corresponding angular period of the equiangular radial lines 308, and/or at least 1%, 2%, 5%, 10%, 20%, or 50% of the corresponding azimuthal lines 306 period, for example. In some embodiments, the amplitudes of the offsets are less than a fixed threshold distance, e.g. less than 2 mm, 5 mm, or 10 mm. It is noted for clarity that the dashed lines 300, 302, 304, and 306 shown in FIGS. 3A, 3B, 3D, 3E, and 3F are virtual lines drawn for the purpose of illustration and do not necessarily denote actual electrical traces.

A total field of view of the NEO 100 may be separated into several viewing cones or regions of different levels of importance or frequency of use. For example, referring to FIG. 4, an NEO, such as the NEO 100 of FIG. 1, may include a central viewing area A of no greater than 12 degrees away from an optic axis, a first peripheral viewing area B, a second peripheral viewing area C, a third peripheral viewing area D, and an outside area E, with the step of 12 degrees up, i.e. 24 degrees, 36 degrees, etc. In many NEO applications, the eye spends most of the time gazing in a direction of the central viewing area A. Accordingly, in some embodiments, the inconspicuous electrical components are placed in the areas B, C, and D, while avoiding the central viewing area A. In other words, the plurality of inconspicuous electrical components lacks electrical components disposed in the central viewing area A, that is, within 12 degrees of an optic axis of the clear aperture. Since the eye spends most of the time gazing within the central viewing area A lacking the electrical components, the latter are less noticeable when disposed outside of the central viewing area A.

Various types of NEO 100 of FIG. 1 may benefit from inconspicuous electronic components within the clear aperture of the NEO 100. Referring to FIG. 5A, an NEO 500A has a form factor of a pair of eyeglasses 501. The NEO 500A includes an active focusing optic 502 having a tunable or switchable optical power. Herein, the term “optical power”, when applied to a component, refers to focusing or defocusing power commonly expressed in Diopters. The active focusing optic 502 has an optic axis 504 and may include, for example, a tunable lens such as a liquid lens or a liquid crystal (LC) lens, a switchable lens such as Pancharatnam-Berry phase (PBP) LC lens for dynamic, e.g. gaze-dependent, correction of vision defects such as myopia, presbyopia, etc. The tunable or switchable lens may be controlled by a controller 506 and/or also be manually controlled by means of a finger dial 508. The inconspicuous electrical components for this type of device may include, for example, inconspicuous transistors, resistors, switches, sensors, etc.

Referring to FIG. 5B, an NEO 500B has a form factor of the pair of eyeglasses 501. The NEO 500B includes an attenuator 510 having a tunable or switchable optical attenuation level, commonly expressed in decibels (dB). The NEO 500B is essentially a pair of tunable or switchable sunglasses, with attenuation adjustable by the finger dial 508. The attenuation may also be gaze-dependent. The inconspicuous electrical components for this type of device may include, for example, inconspicuous photodetectors 512 which measure the illumination level in the clear aperture of the NEO 500B with the purpose of e.g. stabilizing the illumination level at some pre-defined user-selectable value. For example, when the wearer of the NEO 500B enters a shade, the attenuation level of the attenuator 510 may automatically decrease, thus avoiding a problem of low visibility in the shaded areas—a common problem with regular sunglasses. Conversely, when the wearer of the NEO 500B enters a sunlit area, the attenuation level of the attenuator 510 may increase accordingly, keeping the illumination level within comfortable levels regardless of an ambient level of illumination. The NEO 500B may also include an optical shutter for blocking external light completely, e.g. when switching from a glasses mode to a virtual reality display mode.

Turning to FIG. 5C, an NEO 500C has a form factor of the pair of eyeglasses 501. The NEO 500C includes a near-eye tracker (NET) for dynamically tracking an eye region of a user, i.e. an area of the face including both eyes. The NEO 100 includes a substrate 514 having a clear aperture 516 with an optic axis 518. The substrate 514 supports a plurality of inconspicuous illuminators 515, e.g. vertical-cavity surface-emitting lasers (VCSELs), which may be configured and oriented to illuminate the eye area, typically with infrared light 520 to avoid distracting the user with bright visible light. The clear aperture 516 of the substrate 514 may be made transparent for visible light, such as external light from outside environment. The substrate 514 may include an optical element, such as a switchable lens or a switchable grating, for redirecting a least a portion of the illuminating light 520 reflected from the eye region towards an imaging system 522 for imaging the eye region. The eye region may include eye brows, nose bridge, outer canthus of both eyes, and down to the check bone under both eyes. The eye region includes the eye itself and of particular interest to gaze tracking are the cornea, the iris, and the pupil. At least one of the following may be tracked: a position or orientation of user's eye(s); a position of cornea, iris, or pupil of each eye; position or state of eyelid(s) such as open or closed, position or shape of eyebrows, a facial expression; etc.

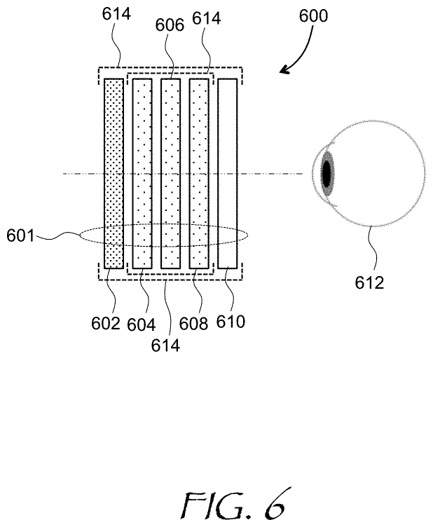

Referring to FIG. 6, an NEO 600 is an embodiment of the NEO 100 of FIG. 1, the active focusing NEO 500A of FIG. 5A, the variable attenuator/shutter NEO 500B of FIG. 5B, or the NET NEO 500C of FIG. 5C. The NEO 600 of FIG. 6 includes a stack 601 of functional substrates 602, 604, 606, 608, and 610, each substrate serving a dedicated function, such as light guiding and coupling, light attenuation or amplification, illumination of user's eye region, outside illumination, distances sensing, etc. The functional substrates 602, 604, 606, 608, and 610 may include, for example, transparent near-eye display units for displaying images to an eye 612, transparent pupil-replicating waveguides of an augmented reality (AR) display system, opaque display units or pupil-replicating waveguides of a virtual reality (VR) display system, prescription lenses having active optics with switchable or tunable optical power, that is, focusing/defocusing power, optical structures with variable transmission for blocking or or attenuation of the outside light, switchable diffraction gratings, Bragg gratings, holographic gratings, sensor substrates, etc. Various combined functions and smart applications may be enabled by stacking various functional substrates, such as gaze-dependent eyesight correction, gaze-dependent light attenuation and conditioning, image and video displaying, outside illumination, etc. The stack 601 may be provided with spacers 614 that keep individual functional substrates 602, 604, 606, 608, and 610 in a pre-defined spaced apart relationship. The stack 601 may be fixed or reconfigurable. The spacers 614 may be bulk spacers and/or beads of glass or another material embedded in a perimeter epoxy gasket. Alternatively, each element in the optic assembly could be built on top of the previous element in a process like over molding.

The functional substrates 602, 604, 606, 608, and 610 may include inconspicuous electrical components in-sight of the eye 612, i.e. within clear apertures of the transparent substrate units. As noted above, VCSEL illuminators mounted on transparent substrates within the clear aperture can be used for illumination of the eye region of the user's face. Placement of the illuminators in the line of sight of the user has advantages of a more uniform illumination and eye gaze detection with a higher fidelity. Traces may be applied to one or more of the surfaces of the functional substrates 602, 604, 606, 608, and 610. In some embodiments the functional substrates 602, 604, 606, 608, and 610 are multilayered. In some embodiments the functional substrates 602, 604, 606, 608, and 610 are composed of (for example) glass, sapphire, film, or plastic.

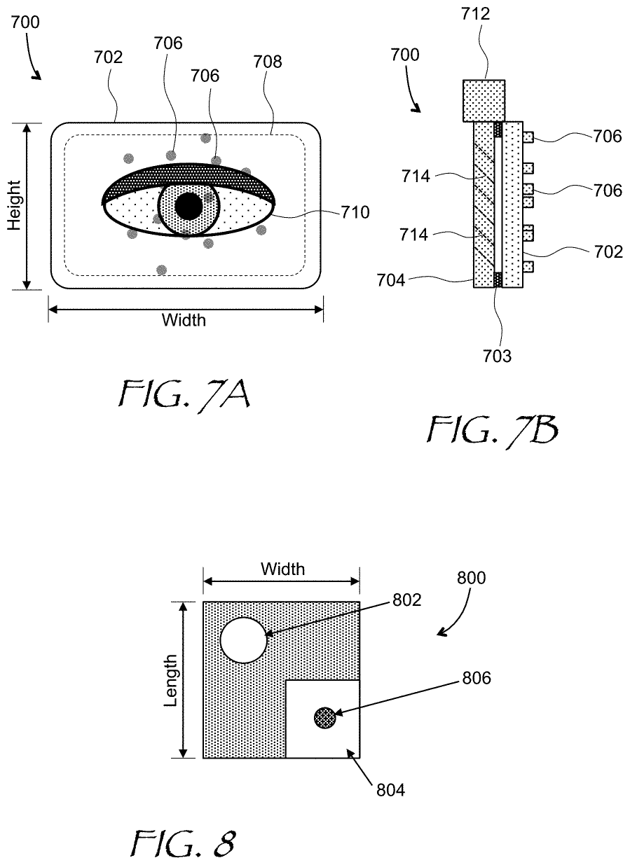

Referring to FIGS. 7A and 7B, an NET 700 includes an eye-tracking illumination substrate 702 and an eye-tracking imaging substrate 704 in a stack configuration. The eye-tracking illumination substrate 702 includes illuminators 706 for illuminating the eye region. The illuminators 706 are disposed in an inconspicuous pattern, e.g. a pattern of FIGS. 3A to 3F, in a clear aperture 708 of the eye-tracking illumination 702 and imaging 704 substrates in the field of view of a user's eye 710. The eye-tracking illumination 702 and imaging 704 substrates can be transparent for visible light across the clear aperture 708. An imaging system 712, e.g. a camera system coupled to an optical sensor, can be optically coupled to the eye-tracking imaging substrate 704. The eye-tracking imaging substrate 704 includes am optical element 714 such as, for example, a holographic, refractive, or diffractive optic for redirecting a least a portion of the illuminating light reflected from the eye 710 towards the imaging system. The eye-tracking illumination 702 and imaging 704 substrates can be held in a spaced apart relationship by a spacer 703. In some embodiments, the width and the height of the NET are between 30×30 mm and 150×150 mm. Thicknesses of each one of the eye-tracking illumination 702 and imaging 704 substrates may be e.g. between 0.25 mm and 10 mm.

Referring to FIG. 8, a VCSEL 800 is suitable for eye region illumination in NET devices. For example, the VCSELs 800 can be used as illuminators 515 in the NET 500C of FIG. 5C, or as the illuminators 706 in the NET 700 of FIGS. 7A and 7B. The VCSEL 800 (FIG. 8) includes a light emission area 802 and an electrical contact area 804. The light emission area 802 may contain beam shaping, directing, and/or collimating optics for providing desired characteristics of emitted optical beam such as divergence, chief ray angle, etc. The optics may include refractive optics, diffractive optics, micro- or nanostructures with desired optical characteristics, etc. The electrical contact area 804 may include a top electrode disposed over a bottom electrode. In some embodiments, the electrical contact area may include a via 806 electrically coupling the top area to a bottom area directly under the top area, such that both electrical terminals of the VCSEL structure are conveniently disposed at the bottom of the VCSEL. The length and width of the VCSEL 800 can be less than 500 μm allowing an inconspicuous use at an eye relief distance closer than 25 mm. Preferably, the length and width of the VCSEL 800 are less than 100 μm, such that the VCSEL 800 is imperceptible to an outside observer who is greater than 200 mm away from the user.

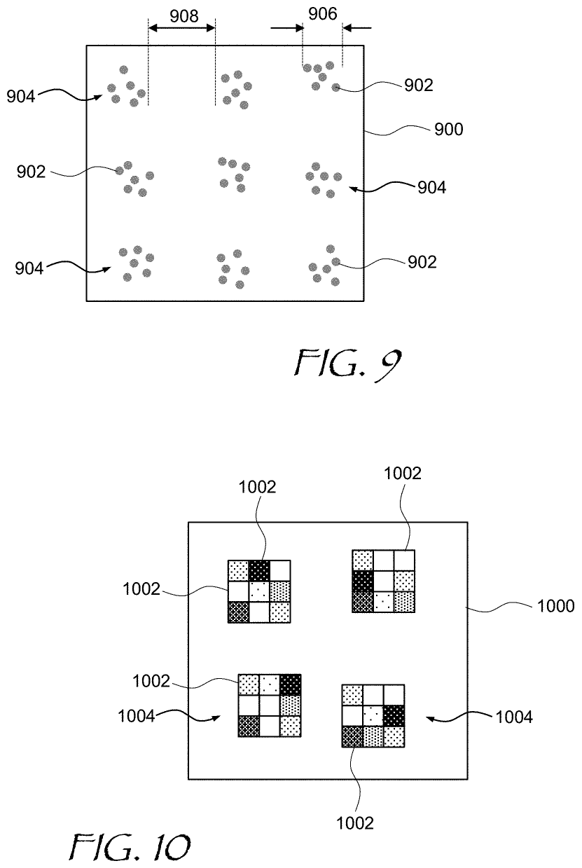

In some NET embodiments, individual illuminators can be provided with a plurality of illuminator-specific characteristics or features, which may make identification of reflections of the illuminators in a user's eye (“glints”) more straightforward. Referring to FIG. 9, an illumination substrate 900 supports a plurality of illuminators 902 grouped in individually shaped clusters 904. Each cluster 904 has its own unique “signature” disposition of individual illuminators 902. A distance between any two illuminators 902 in any cluster 904 is less than a maximum cluster size 906, and a distance between any two clusters 904 is greater than a minimal inter-cluster distance 908. To keep the illuminators 902 clustered such that glints of the clusters are recognizable by the imaging system, the maximum cluster size 906 may be e.g. 1.5 mm, 3 mm, 4.5 mm, or 6 mm, and minimal inter-cluster distance 908 may be e.g. 4 mm, 7 mm, 11 mm, 14 mm. This may allow the detection system to associate corresponding detected reflections with originating illuminator clusters 904, thereby avoiding uncertainty with determining origins of the glints. Consequently, the eye gaze direction and position may be determined in a more reliable and robust manner. Other types of inconspicuous electrical components may also be clustered in this manner.

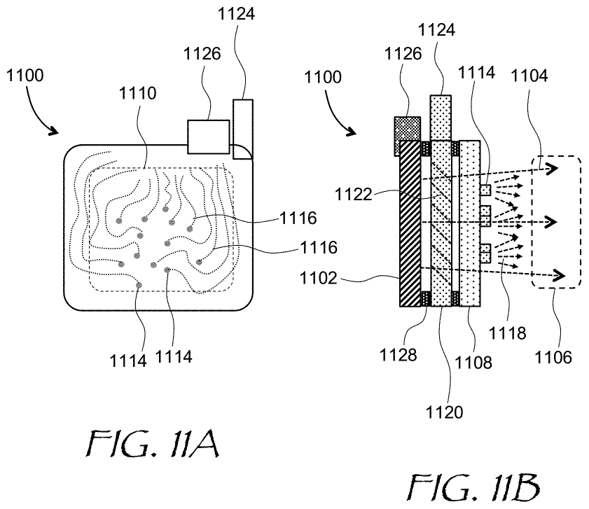

FIG. 10 shows another example of illuminators with unique features. An illumination substrate 1000 of FIG. 10 includes illuminators 1004, which are extended light sources having individual, different, identifiable lateral optical power density distributions schematically illustrated with a set of squares 1002 with different shadings. Squares 1002 are only used as an example, any other suitable shapes may be used. The individual optical power density distributions can serve as “signatures” of individual illuminators 1004. To obtain specific optical power density distributions, the illuminators 1004 may be provided with unique amplitude, phase, or amplitude/phase masks creating required “signature” optical power density distributions. The gaze detection system may be able to recognize the signature optical power density distributions, thereby improving reliability of glint identification and gaze determination.

In some embodiments, individual illuminators, being point-source or extended light sources, groups of illuminators, etc. may have different, pre-defined optical power levels. The gaze detection system may be able to determine the origins of individual glints by comparing optical power levels from different glints on an eye image. In some embodiments, the distance and directivity of individual illuminators may be selected such as to avoid two illuminators shining within a corneal area of a user's eye at once, thereby lessening maximum optical power entering the eye and potentially reaching a retina of the eye. Furthermore, a minimum distance between individual illuminators may be selected such as to avoid coalescence of individual glints and thus improve robustness of detecting the eye position and gaze direction. By way of a non-limiting example, the illuminators can be disposed at least 5 mm away from each other.

Turning to FIGS. 11A and 11B, a near-eye display (NED) 1100 includes an electronic display 1102 for providing display light 1104 carrying an image to be displayed to an eyebox 1106 of the NED 1100. The eyebox 1106 is a geometrical area where image of an acceptable quality may be displayed to the user. An illumination substrate 1108 has a clear aperture 1110 (FIG. 11A) in a field of view of the NED 1100. The illumination substrate 1108 is transparent to the display light 1104 in the clear aperture 1110, allowing the display light 1104 to propagate through the clear aperture 1110 to the eyebox 1106. A plurality of inconspicuous illuminators 1114, disposed in an inconspicuous pattern, e.g. any of the patterns of FIGS. 3A to 3F described above, are supported by the illumination substrate 1108 (FIG. 11B) in the clear aperture 1110 of the illumination substrate 1108. The inconspicuous illuminators 1114 are electrically coupled to a plurality of inconspicuous conductive traces 1116 for providing electrical power to the plurality of inconspicuous illuminators 1114, which generate illuminating light 1118 when energized. Typically, a near-infrared light, with a wavelength of between 700 nm and 1100 nm, is used for illumination of the user's eye area. The near-infrared light with a wavelength of between 700 nm and 1100 nm is not visible by a human eye while is detectable by commonly used silicon sensors.

The NED 1100 may further include an imaging substrate 1120. The imaging substrate 1120 performs the function of collecting light reflected from the eye area. Just like the illumination substrate 1108, the imaging substrate 1120 is transparent to the display light 1104 in the clear aperture 1110. The imaging substrate 1120 may include reflective or diffractive optics 1122 redirecting a least a portion of the illuminating light reflected from the eye region towards an imaging system 1124, which collects the reflected light and obtains an image of the eye region. A position of the eye pupil in the obtained image may then be determined. Positions of glints from the illuminators 1114 are also determined, and the corresponding originating illuminators 1114 are then identified. From this information, one can determine the gaze direction in real time with a good fidelity.

In some embodiments, the electronic display 1102 is based on a pupil-replicating waveguide, which can be configured for guiding the display light generated by a projector 1126 via a series of total internal reflections from it's outer surfaces, and outputting the display light at a plurality of offset locations at the proximal outer surface, that is, the surface facing the user and the eyebox 1106, of the pupil-replicating waveguide. In FIG. 11B, the proximal outer surface of the pupil-replicating waveguide is facing a distal surface, that is, a surface away from the user and the eyebox 1106, of the imaging substrate 1120. The illumination substrate 1108, the imaging substrate 1120, and the pupil-replicating waveguide of the display substrate 1102 are disposed in a stack configuration, with spacers 1128 defining required distances between the substrates. The relative position of the substrates may vary, e.g. the electronic display 1102 may be the closest substrate to the eyebox 1106.

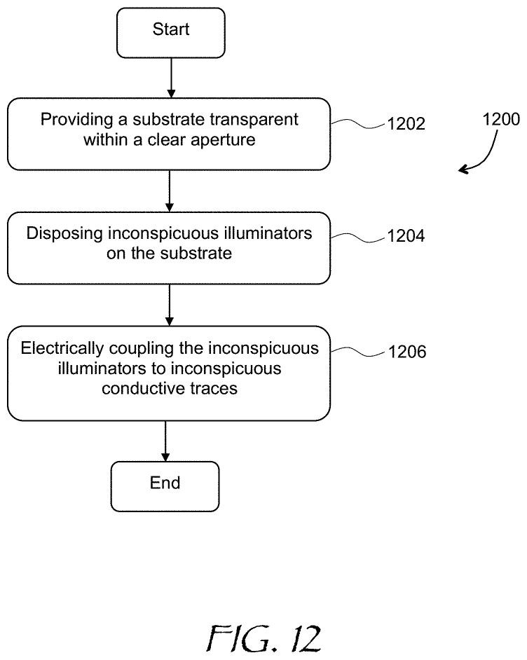

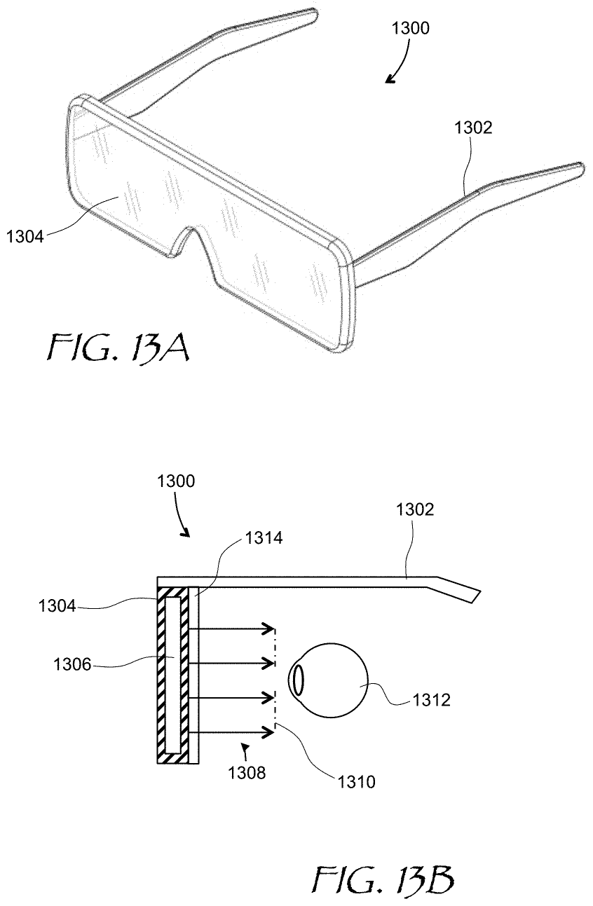

Referring now to FIG. 12, a method 1200 of manufacturing a near-eye optic of the present disclosure includes providing (1202) a substrate having a clear aperture for propagating light through the clear aperture. For example, the substrate 514 of FIG. 5C, functional substrates 602, 604, 606, 608, and 610 of FIG. 6, the eye-tracking illumination substrate 702 of FIG. 7B, or the illumination substrate 1108 of FIG. 11B may be provided. The substrate may have a thickness of e.g. between 0.25 mm and 10 mm. A material of the substrate may include e.g. plastic, glass, fused silica, sapphire, etc. Inconspicuous electrical components are then disposed (1204) within the clear aperture of the substrate, as shown above with reference to FIGS. 1 and 2 (the electrical components 108), FIG. 5C (the illuminators 515), FIGS. 7A, 7B (the illuminators 706), FIGS. 11A, 11B (the illuminators 1114). The electrical components are preferably disposed in an inconspicuous pattern, e.g. at least one of an asymmetric pattern, an aperiodic pattern, a pseudo-random pattern, a meandering pattern, a periodic pattern modulated with pseudo-random perturbations, or a non-rectangular pattern illustrated in FIGS. 3A to 3F, or a clustered pattern of FIG. 9. The plurality of inconspicuous electrical components can be coupled (1206) to a plurality of inconspicuous conductive traces, as shown e.g. in FIG. 1 (inconspicuous conductive traces 110) or FIG. 11A (inconspicuous conductive traces 1116).

In some embodiments, the plurality of inconspicuous electrical components lacks electrical components disposed within 12 degrees of an optic axis of the clear aperture, as illustrated in FIG. 4. The clear aperture of the substrate can be transparent or translucent for visible light.

Referring to FIGS. 13A and 13B, a near-eye AR/VR display 1300 is an embodiment of a NED, or more generally a wearable display. A body or frame 1302 of the near-eye AR/VR display 1300 has a form factor of a pair of eyeglasses, as shown. A display 1304 includes a display assembly 1306 (FIG. 13B), which provides image light to an eyebox 1310. The display assembly 1306 may include a separate display module for each eye, or one display module for both eyes.

The near-eye AR/VR display 1300 may include an NET 1314 of the present disclosure, including illuminators e.g. VCSELs, for illuminating the eye 1312 with infrared beams 1308, and an imaging system for taking images of illuminated eye 1312 with glints from the illuminators and, based on the glints and the detected eye pupil, determining the gaze direction of the user's eye 1312. The illuminators may be disposed on or near inner surface of the display assembly 1306, with electric leads inconspicuously placed on the display assembly 1306. The determined gaze direction and vergence angle may also be used for real-time compensation of visual artifacts dependent on the angle of view and eye position. Furthermore, the determined eye 1312 vergence and gaze angle may be used for dynamic interaction with the user.

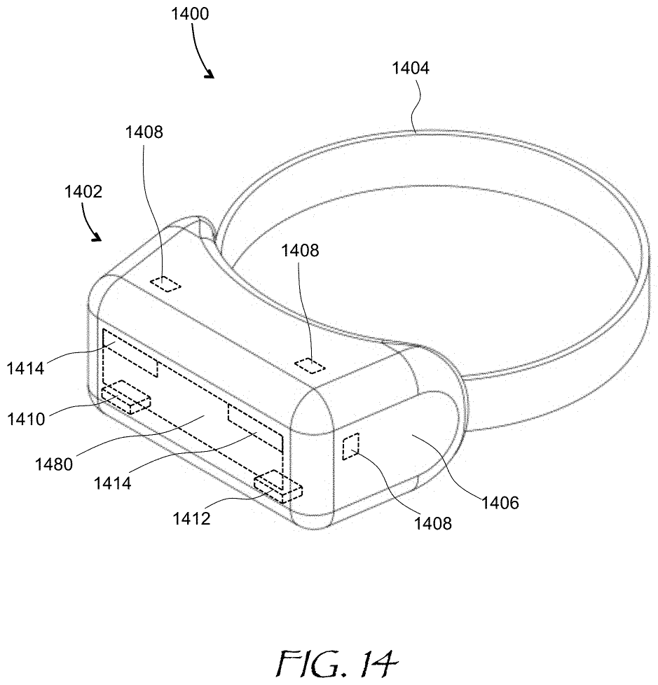

Turning to FIG. 14, a head-mounted display (HMD) 1400 is an example of an AR/VR wearable display system which encloses the user's face, for a greater degree of immersion into the AR/VR environment. The HMD 1400 can present content to a user as a part of an AR/VR system, not shown. The AR/VR system may further include a user position and orientation tracking system, an external camera, a gesture recognition system, control means for providing user input and controls to the system, and a central console for storing software programs and other data for interacting with the user for interacting with the AR/VR environment. The function of the HMD 1400 is to augment views of a physical, real-world environment with computer-generated imagery, and/or to generate the entirely virtual 3D imagery. The HMD 1400 may include a front body 1402 and a band 1404. The front body 1402 is configured for placement in front of eyes of a user in a reliable and comfortable manner, and the band 1404 may be stretched to secure the front body 1402 on the user's head. A display system 1480 is disposed in the front body 1402 for presenting AR/VR imagery to the user. An electronic display of the display system may include, for example and without limitation, a liquid crystal display (LCD), an organic light emitting display (OLED), an inorganic light emitting display (ILED), an active-matrix organic light-emitting diode (AMOLED) display, a transparent organic light emitting diode (TOLED) display, a projector, or a combination thereof. Sides 1406 of the front body 1402 may be opaque or transparent.

In some embodiments, the front body 1402 includes locators 1408, an inertial measurement unit (IMU) 1410 for tracking acceleration of the HMD 1400, and position sensors 1412 for tracking position of the HMD 1400. The locators 1408 are traced by an external imaging device of a virtual reality system, such that the virtual reality system can track the location and orientation of the entire HMD 1400. Information generated by the IMU and the position sensors 1412 may be compared with the position and orientation obtained by tracking the locators 1408, for improved tracking of position and orientation of the HMD 1400. Accurate position and orientation is important for presenting appropriate virtual scenery to the user as the latter moves and turns in 3D space.

The HMD 1400 further includes an eye tracking system 1414 including in-sight illuminators, e.g. VCSELs, and an imaging camera, one tracking system 1414 for each eye. The eye tracking systems 1414 which determine orientation and position of user's eyes in real time. The obtained position and orientation of the eyes allows the HMD 1400 to determine the gaze direction of the user and to adjust the image generated by a display system 1480 accordingly. The determined gaze direction and vergence angle may also be used for real-time compensation of visual artifacts dependent on the angle of view and eye position. Furthermore, the determined vergence and gaze angles may be used for interaction with the user, highlighting objects, bringing objects to the foreground, creating additional objects or pointers, etc. An audio system may also be provided including e.g. a set of small speakers built into the front body 1402.

What is claimed is:

1. A near-eye optic comprising:
a substrate having a clear aperture for propagating light therethrough; and
a plurality of inconspicuous electrical components supported by the substrate in the clear aperture of the substrate, wherein the inconspicuous electrical components are electrically coupled to a plurality of inconspicuous conductive traces.

2. The near-eye optic of claim 1, wherein the electrical components are disposed at least 5 mm away from each other.

3. The near-eye optic of claim 1, wherein the electrical components have a width and a length of less than 0.5 mm.

4. The near-eye optic of claim 1, wherein the plurality of inconspicuous electrical components lacks electrical components disposed within 12 degrees of an optic axis of the clear aperture.

5. The near-eye optic of claim 1, wherein the substrate is transparent for visible light across the clear aperture.

6. The near-eye optic of claim 1, comprising at least one of: a display, a prescription lens, an active focusing optic, an attenuator, or a shutter.

7. The near-eye optic of claim 1, wherein the electrical components are disposed in a plurality of individually shaped clusters of components, wherein a distance between any two components in a cluster of the plurality of clusters is less than a cluster size, and wherein a distance between any two clusters of the plurality of clusters is greater than a minimal inter-cluster distance.

8. The near-eye optic of claim 1, comprising a near-eye tracker, wherein the electrical components comprise illuminators configured to provide illuminating light to an eye region for eye tracking.

9. The near-eye optic of claim 8, wherein at least one of: the illuminators have different pre-defined optical power levels, or the illuminators comprise extended light sources, each extended light source having a different lateral distribution of optical power density.

10. The near-eye optic of claim 8, wherein the near-eye tracker comprises an imaging system for imaging the eye region, wherein the substrate comprises an optical element for redirecting a least a portion of the illuminating light reflected from the eye region towards the imaging system.

11. The near-eye optic of claim 10, wherein the optical element comprises at least one of a switchable lens or a switchable grating.

12. A near-eye display (NED) comprising:
an electronic display for providing display light to an eyebox of the NED;
an illumination substrate having a clear aperture in a field of view of the NED for propagating the display light from the electronic display through the clear aperture; and
a plurality of inconspicuous illuminators for providing illuminating light to an eye region of a user of the NED;
wherein the inconspicuous illuminators are supported by the illumination substrate in the clear aperture thereof; and
wherein the inconspicuous illuminators are electrically coupled to a plurality of inconspicuous conductive traces for providing electrical power to the plurality of inconspicuous illuminators.

13. The near-eye display of claim 12, further comprising:
an imaging system; and
an imaging substrate in a stack configuration with the illumination substrate, the imaging substrate comprising an optical element for redirecting a least a portion of the illuminating light reflected from the eye region towards the imaging system.

14. The near-eye display of claim 13, wherein the electronic display comprises a pupil-replicating waveguide for guiding the display light and outputting the display light at a plurality of offset locations at a proximal outer surface of the pupil-replicating waveguide.

15. The near-eye display of claim 14, wherein the illumination substrate, the imaging substrate, and the pupil-replicating waveguide are disposed in a stack configuration, and wherein the proximal outer surface of the pupil-replicating waveguide is facing a distal surface of the imaging substrate.

16. A method of manufacturing a near-eye optic, the method comprising:
providing a substrate having a clear aperture for propagating light therethrough;
disposing within the clear aperture of the substrate a plurality of inconspicuous electrical components; and
electrically coupling the plurality of inconspicuous electrical components to a plurality of inconspicuous conductive traces.

17. The method of claim 16, wherein the inconspicuous conductive traces are disposed in an inconspicuous pattern comprising at least one of: an asymmetric pattern, an aperiodic pattern, a pseudo-random pattern, a meandering pattern, a periodic pattern modulated with pseudo-random perturbations, or a non-rectangular pattern.

19. The method of claim 16, wherein the plurality of inconspicuous electrical components lacks electrical components disposed within 12 degrees of an optic axis of the clear aperture.

20. The method of claim 16, wherein the clear aperture of the substrate is transparent for visible light.
